(19) United States
(12) Patent Application Publication
(10) Pub. No.: US 2026/0351871 A1
(43) Pub. Date: Nov. 5, 2026

(54) CONNECTION SYSTEM FOR CONNECTION WITH A FLAT CABLE AND ASSOCIATED SYSTEM

(71) Applicant: Lapp Engineering AG, Cham (CH)

(72) Inventors: Stevens SEHIC, Neu-Ulm (DE); Joachim Strobel, Unterensingen (DE); Alexander Denk, Dillingen (DE)

(73) Assignee: Lapp Engineering AG, Cham (CH)

(21) Appl. No.: 19/664,411

(22) Filed: Apr. 30, 2026

(30) Foreign Application Priority Data
May 5, 2025 (DE) 10 2025 117 149.1

(51) Int. Cl. H01R 9/03; H01R 4/2406; H01R 4/2475; H02G 15/117

(52) U.S. Cl. CPC H01R 9/03; H01R 4/2406; H01R 4/2475; H02G 15/117

(57) ABSTRACT

A system for connection of a connection system with a first flat cable having a plurality of wires and/or with a second flat cable having a plurality of wires is provided. The first flat cable comprising first wires arranged in a width direction of the first flat cable and each having a first conductor cross section, wherein all the distances between centre axes of adjacent wires are identical. The second flat cable comprising second wires arranged in a width direction of the second flat cable and each having a second conductor cross section, wherein all the distances between centre axes of adjacent wires are identical and correspond to the distances of the first flat cable. The first conductor cross section and the second conductor cross section differ from one another and/or the first number of wires and the second number of wires differ from one another.

This application claims the benefit of the German patent application No. 10 2025 117 149.1 filed on May 5, 2025, the entire disclosure of which is incorporated herein by way of reference.

### FIELD OF THE INVENTION

The invention relates to a system for connection of a connection system with a first flat cable having a plurality of wires and/or with a second flat cable having a plurality of wires. The invention relates further to a corresponding connection system. In particular, the invention relates to a connection system which allows an electrical connection to be established with a flat cable without interrupting the electrical conduction through the flat cable.

### BACKGROUND OF THE INVENTION

Flat cable terminal boxes or flat cable junction boxes which permit connection to a flat cable without insulation displacement are known from the prior art. Also known are corresponding flat cables having a plurality of wires with which the respective terminal box or junction box can be connected and in particular electrically contacted.

Document DE 10 2007 041 815 A1 discloses a corresponding device for producing a connection to a flat cable without insulation displacement.

In connection systems of the prior art, it is necessary at present to provide a separate box for each type of flat cable in order to take account of the different dimensions of the flat cable in question and in order to provide corresponding contacts for the corresponding number of wires. In order to securely hold and securely contact the flat cable in question, there should as far as possible be no space to the side of or above or below the flat cable. It is thus necessary to provide for each size (in particular for each thickness of flat cable and for each width of flat cable) a separate connection system that is able to receive a flat cable of the corresponding thickness and of the corresponding width with an accurate fit. Furthermore, the needles for the electrical contacting of the wires of the flat cable in question must be arranged in the connection system with an accurate fit for the type of cable to be connected. Existing connection systems can thus only ever be used for one type of flat cable or for a limited group of types of flat cable, which represents a problem in terms of flexibility. This is also made more difficult in particular by the fact that different types of flat cable of the prior art (in particular flat cables having a different number of wires and/or different conductor cross sections) have different distances between their individual wires, so that a separate connection system that is adapted to the particular distances between the individual wires must be provided for each individual type of flat cable.

In the prior art, this situation also has the result that every design of a connection system requires an independent UL certification, which leads to additional costs and additional effort.

### SUMMARY OF THE INVENTION

One object of the invention is to provide a system for connection of a connection system with a first flat cable having a plurality of wires and/or with a second flat cable having a plurality of wires that solves at least one of the problems outlined above and/or a problem associated therewith. In particular there is to be provided a modular connection system that allows connection to different types of flat cable. A further object of the invention is to provide a connection system that solves at least one of the problems outlined above and/or a problem associated therewith.

According to the invention, the object is achieved according to a first aspect by a system for connection of a connection system with a first flat cable having a plurality of wires and/or with a second flat cable having a plurality of wires. The system comprises (a) the first flat cable comprising a first number of wires arranged in a width direction of the first flat cable and each having a first conductor cross section, wherein all the distances between centre axes of adjacent wires are identical. The system further comprises (b) the second flat cable comprising a second number of wires arranged in a width direction of the second flat cable and each having a second conductor cross section, wherein all the distances between centre axes of adjacent wires are identical and correspond to the distances of the first flat cable. The first conductor cross section and the second conductor cross section differ from one another and/or the first number of wires and the second number of wires differ from one another. The system further comprises (c) the connection system. The connection system comprises a housing for receiving the flat cable to be connected such that the flat cable to be connected runs through the housing in a first direction. The connection system comprises at least three receivers for in each case one needle for piercing in each case one of the wires of the flat cable to be connected. The at least three receivers are so arranged that, in a received state of the needles, the needles of the at least three receivers are arranged at the same distance from one another with respect to the width direction, perpendicular to the first direction, of the flat cable to be connected, said distance corresponding to the distance between the centre axes of the wires of the first flat cable and of the second flat cable.

Because both the first and the second flat cable have the same distances between the centre axes of the adjacent wires, the connection system (i.e. the same connection system) can be used to contact different types of flat cable, in particular flat cables having a different number of wires and/or having a different conductor cross section. This is possible because the distances between the needles of the connection system correspond to the distances between the wires of the different types of flat cable. As a result, a flexible design of the connection system and of the associated flat cable is possible. Any reference herein to "distances between wires" of a cable always means the distances between the centre axes of the wires in question and not the distances of the outer surfaces of the wires in question (unless this is explicitly denoted as such).

Examples of types of flat cable are 5 G 2.5, 5 G 4, 5 G 6, 3 G 2.5, 3 G 4 and 3 G 6. The first number (i.e. in the above example 5 or 3) represents the number of wires, the letter G represents the presence of a green-yellow protective earth conductor, and the second number (i.e. in the above example 2.5, 4 or 6) represents the conductor cross section in mm². However, the present disclosure is not limited to the types of flat cable mentioned above. A particular feature of the flat cables described herein is that, in the different types of flat cable, the distances between adjacent wires are identical. Flat cables having a smaller number of wires thus have the same distances between the wires as flat cables having a larger number of wires. Furthermore, flat cables having a smaller conductor cross section have the same distances between the wires as flat cables having a larger conductor cross section. The types of flat cable outlined above thus do not describe known flat cables of the prior art but new types of flat cable having an identical distance between the adjacent wires.

In some exemplary embodiments, it is possible to use conventional screw fastenings and quick-acting closures with a base variant.

Some exemplary embodiments can be suitable for AC and DC applications.

In some exemplary embodiments, it can be sufficient to undergo a single certification process for the connection system, which can be used with multiple types of flat cable (see above).

The system comprises the first flat cable and the second flat cable, wherein in each case one of these two flat cables can be connected with the connection system. This particular flat cable (i.e. the first flat cable or the second flat cable) is also referred to herein as the flat cable to be connected. In particular, it can be possible to connect either the first or the second flat cable with the same connection system. In some embodiments, it can be possible, for example, first to connect the connection system with the first flat cable and then to detach it from the first flat cable in order to connect it with the second flat cable. The first number of wires can be 3, for example, and the second number of wires can be 5. Ultimately, the number of wires of the flat cables in question can be chosen as desired. Furthermore, the first conductor cross section can be 2.5 mm² and the second conductor cross section can be 4 mm² or 6 mm². Ultimately, the conductor cross section of the flat cables in question can be chosen as desired. Within the first flat cable and/or the second flat cable, the conductor cross section of all the wires can be identical to one another. If, for example, a conductor cross section is indicated for the cable in question (e.g. 2.5 mm²), then this describes the conductor cross section of all the wires of the cable in question. The first flat cable and the second flat cable thus differ in terms of the number of wires and/or in terms of the conductor cross section. It is crucial, however, that, despite the different number of wires and/or different conductor cross section, a distance between the individual wires is the same in both cables.

The housing of the connection system can be connectable with the flat cable to be connected by screwing, for example. In particular, the housing can comprise a main box and a base plate. The main box is adapted to be arranged on an upper side of the flat cable, and the base plate is adapted to be arranged on a lower side of the flat cable opposite the upper side of the flat cable. For fastening the connection system to the flat cable, the main box can be screwed to the base plate and/or one or more snap closures (so-called quick-acting closures) can be provided for connecting the main box with the base plate. A connection between the main box and the base plate can be detachable. The flat cable is clamped between the main box and the base plate. When the housing is connected with the flat cable in the manner described above, this is referred to hereinbelow as the "connected state".

The connection system can be so designed that it delivers acoustic feedback on connection with the flat cable. In the case of the snap closure, this can be effected, for example, by a snapping sound of the snap closure. It can thus be indicated to a user in a simple manner that the connection has been made correctly. Furthermore, the main box can be connected with the base plate using special screws that can be opened only with a special tool, that is to say in particular not commercial slotted screws, cross-head screws. It can thus be ensured that the connection system cannot easily be opened by just anyone (for example for safety reasons).

The first direction is a direction of extent of the wires of the flat cable to be connected in the connected state. The housing can, for example, be so designed that it is substantially cuboidal, wherein a longest side of the cube extends in the first direction.

The first and/or the second flat cable can have, for example, a conductor cross section of 2.5, 4 or 6 mm². The first and/or the second flat cable can in particular be in each case one of the following types: 5 G 2.5, 5 G 4, 5 G 6, 3 G 2.5, 3 G 4 and 3 G 6, but not the same types.

The receivers for the needles can, for example, each comprise a screw thread for screwing in the needle in question. Furthermore, a separate screw can be provided, said screw, when it is screwed in, pressing the needle into a respective wire of the flat cable. The receiver can allow the needle to be electrically connected with a wire of a connecting cable. The connecting cable can be guided out of the housing through an opening in the housing. Alternatively, the receiver can allow the needle to be electrically connected with a cable that is connected with a connector box provided in a wall of the housing. A connecting cable can be connected to the connector box, so that an electrical connection of a respective wire of the connecting cable with a respective wire of the flat cable can be established and maintained.

Penetration of the needle into the cable (more precisely, into the respective conductor of the cable) can be effected by screwing in the needle in the closed state between the base plate and the main box or during connection of the main box with the base plate.

Since the provision of the connecting cable and the connection thereof with one or more needles or contacts is known to the person skilled in the art, these aspects will not be discussed in detail in the following.

The needles can already be connected with the receivers.

The receivers can be provided in the form of a receiving element that forms a coherent unit or in the form of individual receiving elements. It is here relevant only that there is provided for each of the needles a receiver in which the respective needle can be received. There can be, but does not have to be, a possible structural connection of the individual receivers with one another.

The received state describes a state in which all the needles are received in their respective receivers. For example, the needles can already be in the received state in a starting state of the connection system (e.g. on delivery of the connection system). Alternatively, the needles can be inserted into the respective receiver by a user, for example by being screwed in.

The width direction, perpendicular to the first direction, of the flat cable in question is a direction in which the width of the flat cable is measured. In other words, the width direction is a direction in which the individual wires of the flat cable are arranged. That the needles are arranged at the same distance from one another with respect to the width direction means that the components of the distance vectors between needles that are adjacent in the width direction are in each case of identical length in the direction of the width direction. In yet other words, imaginary lines running through the respective needles parallel to the first direction are in each case at the same distance apart from one another. In this manner, a flat cable whose adjacent wires are at the same distance apart from one another can be contacted by the needles. The receivers are so arranged that, in the received state, the needles of all the receivers of the connection system are arranged at the same distance from one another with respect to the width direction. In the first direction, the receivers can be distributed across the connection system in any desired manner.

The connection system can have at least five and in particular exactly five receivers, which are so arranged that, in the received state of the needles, the needles of the at least five receivers are arranged at the same distance from one another with respect to the width direction of the flat cable to be connected.

In particular 5-wired flat cables can here be contacted by the connection system. However, flat cables with fewer than 5 wires, in which the distances between adjacent wires are the same as the distances between the wires of the 5-wired flat cables, can also be contacted with the same connection system.

The connection system can further comprise at least one spacer for filling a space between the flat cable to be connected and the housing.

Because a spacer is provided, this can be adapted to a specific type of flat cable, so that this type of flat cable can be used with the connection system. If the spacer is omitted, a different type of flat cable (i.e. a flat cable with different dimensions, that is to say a different width and/or a different thickness) can be used with the same connection system. Furthermore, different spacers can be provided for different types of flat cable. If the spacers are connected in a detachable manner with the housing, then they can be interchanged for different types of flat cable.

The spacer can contain an additional mechanical coding, in particular in order to establish exclusivity for a particular customer.

The spacer can consist of an electrically insulating material. The spacer can consist of a flexible material. The spacer can be configured to fill the space completely in at least one dimension. That is to say: when the spacer is provided "next to" the flat cable, that is to say adjacent to the flat cable in the width direction of the flat cable, a distance in the width direction between the flat cable and the housing can be filled completely inasmuch as the spacer extends in the width direction from the flat cable to the housing. If, in addition or alternatively, the spacer is provided "above" or "below" the flat cable, that is to say adjacent to the flat cable in the thickness direction of the flat cable, a distance in the thickness direction between the flat cable and the housing can be filled completely inasmuch as the spacer extends in the thickness direction from the flat cable to the housing. The flat cable can thus be clamped by the housing and by the spacer. In particular, the flat cable can be clamped between the housing and the spacer.

The spacer can, for example, not be integrally connected with the housing. In particular, the spacer can be connectable in a detachable manner with the housing. The spacer can thus represent an independent component that can be attached to the housing and optionally removed from the housing again.

The connection system can further comprise at least one fastening means for fastening the spacer to the housing. The fastening means can in particular allow the spacer to be fastened in a detachable manner to the housing. The fastening means can be provided on the spacer and/or on the housing.

The at least one fastening means can comprise a screw. At least one hole for screwing in the screw can be provided in each of the spacer and the housing. At least one of the holes can have a thread. The spacer can thus be screwed to the housing.

The at least one fastening means can comprise a fastening clip. The fastening clip can be formed integrally with the element on which it is provided, that is to say in particular with the spacer or with the housing.

The fastening clip can be provided on the spacer and can be adapted to be inserted into and to latch in an opening provided therefor in the housing. Alternatively, the fastening clip can be provided on the housing and can be adapted to be inserted into and to latch in an opening provided therefor in the spacer. The fastening clip can in each case have a latching projection for latching in the associated opening.

The spacer can be adapted to fill, in an inserted state, a space situated adjacent to the flat cable in a width direction of the flat cable to be connected. The width direction is defined herein as the direction in which the width of the flat cable is measured, in other words as the direction in which the wires of the flat cable are arranged next to one another. The width direction is perpendicular to the first direction, that is to say perpendicular to the direction of extent of the wires of the flat cable.

The spacer can be adapted to fill, in an inserted state, a space situated adjacent to the flat cable in a thickness direction of the flat cable to be connected. The thickness direction is defined herein as the direction in which the thickness of the flat cable is measured. The thickness direction is perpendicular to the first direction, that is to say perpendicular to the direction of extent of the wires of the flat cable, and perpendicular to the width direction. The first direction (direction of extent), the width direction and the thickness direction thus span a Cartesian coordinate system.

The spacer can be adapted to extend, in an inserted state, at least over the entire flat cable in the width direction of the flat cable to be connected. In other words, the spacer can be at least as wide as the associated flat cable.

The spacer can be adapted to extend, in an inserted state, at least over the entire flat cable in the thickness direction of the flat cable to be connected. In other words, the spacer can be at least as thick as the associated flat cable.

The connection system can comprise a plurality of spacers for flat cables of different widths and/or different thicknesses. In particular, the connection system can comprise a plurality of spacers of different dimensions. The plurality of spacers can in each case fulfil the requirements outlined above in respect of their dimensions for different types of flat cable. In other words, a suitable spacer can be provided in each case for different types of flat cable (in particular for different thicknesses and/or different widths). Spacers with different thicknesses and/or with different widths can thus be provided.

The spacer, in an inserted state, can comprise a recess at a position of at least one of the receivers. The recess can be adapted to receive the respective needle when the needle is screwed in. In other words, the recess in the spacer can have the result that the respective needle does not contact the spacer or at least does not penetrate deeply into the spacer. Thus, should one of the needles situated, for the flat cable in question, not adjacent to the flat cable (i.e. above the flat cable) but adjacent to the spacer inadvertently or intentionally be screwed in, it can be ensured by the recess in the spacer that the respective needle and/or the spacer are/is not damaged.

The connection system can further comprise a seal arranged between the housing and the flat cable and having an annular sealing part. When seen from above, the annular sealing part can be, for example, rectangular with rounded corners. In this context, annular means that the sealing part forms a closed ring. The ring does not have to be circular but can in particular be rectangular or rectangular with rounded corners. The seal can be fastened to the housing, in particular adhesively bonded to the housing. The seal can be fastened to an upper side, or main box, of the housing, in other words to a component of the housing from which the at least one needle pierces the flat cable.

The seal can comprise, in addition to the annular sealing part, a sealing part that runs along a contact surface between the flat cable and the spacer. This additional sealing part can thus cover a gap between the flat cable and the spacer.

The connection system can comprise the needle. The needle can be connected non-detachably or detachably with the receiver for the needle.

According to the invention, the object is achieved according to a second aspect by a connection system for connection with a first flat cable having a plurality of wires with a second flat cable having a plurality of wires. The connection system comprises a housing for receiving the flat cable to be connected such that the flat cable to be connected runs through the housing in a first direction. The connection system further comprises at least three receivers for in each case one needle for piercing in each case one of the wires of the flat cable to be connected. The at least three receivers are so arranged that, in a received state of the needles, the needles of the at least three receivers are arranged at the same distance from one another with respect to the width direction, perpendicular to the first direction, of the flat cable to be connected. The connection system further comprises at least one spacer for filling a space between the flat cable to be connected and the housing.

All the details of the connection system which has been described above as part of the system according to the first aspect can apply correspondingly to the connection system of the second aspect.

### BRIEF DESCRIPTION OF THE DRAWINGS

Exemplary embodiments of the invention will be described in greater detail hereinbelow by means of the drawings.

FIG. 1 shows a perspective view of an open connection system according to the present disclosure;

FIG. 2 shows the connection system of FIG. 1 in a closed and connected state;

FIG. 3 shows cross sections through different types of ribbon cables according to the present disclosure and the dimensions thereof;

FIG. 4 shows cross sections through different types of ribbon cable according to the present disclosure, wherein associated spacers are shown in the middle column of the figure and inserted needles are shown in the right-hand column of the figure;

FIG. 5 shows a perspective sectional view of a connection system according to the present disclosure;

FIG. 6 shows top views of different spacers and shows fastening means for spacers;

FIG. 7 shows top views of different flat cables according to the present disclosure and of different spacers and of different types of seal for these elements; and

FIG. 8 shows a perspective outside view of a connection system according to the present disclosure having a snap closure.

### DETAILLED DESCRIPTION OF PREFERRED EMBODIMENTS

In the following, spatial relationships, for example at the top, at the bottom, on the inside, on the outside, etc., are used in order to describe the exemplary embodiments clearly. The person skilled in the art will appreciate that this serves for the clear description and is not to be interpreted as being limiting.

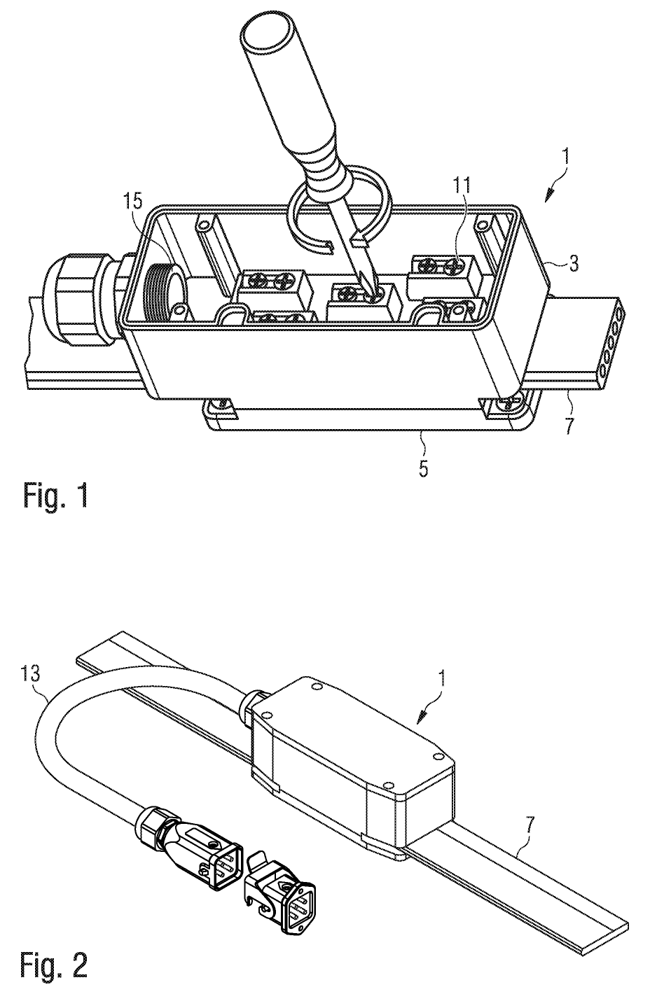

FIG. 1 shows a perspective view of an open connection system according to the present disclosure.

The connection system comprises a housing 1, which is composed of a main box 3 and a base plate 5. The flat cable 7 with which electrical contact is to be established (the flat cable to be connected) is clamped between the main box 3 and the base plate 5. Connection of the connection system with the flat cable 7 can be effected, for example, by means of screws, wherein the base plate 5 is screwed to the main box 3 in order to clamp the flat cable 7 therebetween.

In order to establish electrical contact, that is to say in order to contact the individual wires of the flat cable 7, the connection system has, within the main box 3, a plurality of receivers 11 for needles. For the sake of simplicity, only one of the receivers 11 has been provided with a reference sign by way of example. The needles are adapted to penetrate an insulation of the flat cable 7 as far as the respective conductor and thus establish electrical contact. The receivers 11 can, for example, in each case comprise the needle and a screw which, on actuation of the screw, presses the needle into the respective wire of the flat cable 7. Alternatively, the receivers 11 can in each case comprise a needle which has a thread and, like a screw, can be screwed into the respective wire of the flat cable 7.

As is shown in FIG. 1, an associated receiver 11 is provided for each of the wires to be contacted (in the example shown: five). The individual receivers 11 are arranged offset with respect to one another in the width direction of the flat cable 7 so that in each case one needle is located above an associated wire of the flat cable 7. The respective receivers 11 are each connected or connectable with an associated wire of a connecting cable 13 (not shown in FIG. 1). A suitable terminal for connection of a wire of a connecting cable 13 can thus be provided for each receiver 11. The connecting cable 13 can be guided out of the housing 1 through an opening 15.

It can further be seen in FIG. 1 that adjacent wires of the flat cable 7 are in each case at the same distance from one another. The same is true of the needles of the receivers 11 with respect to the width direction of the flat cable 7. With respect to the width direction of the flat cable 7, the receivers 11 are so positioned on the housing 1 that the needles are in each case arranged at the same distance from one another when they have been received by the respective receiver 11 (in the received state). In this manner, the flat cable 7 can be electrically contacted by the associated needles. In this manner there can further be electrically contacted another flat cable (not shown in FIG. 1) that has a smaller number of wires (e.g. 3), the distances of which from one another are, however, identical to the distances between the wires of the flat cable 7 shown. Alternatively or in addition, there can be electrically contacted another flat cable that has a different conductor cross section than the flat cable 7 shown but in which the distances between the wires are the same as those of the flat cable 7 shown.

FIG. 2 shows a representation of the connection system of FIG. 1 in a closed state (i.e. the main box 3 is closed) and with an associated connecting cable 13. In the connected state, the flat cable 7 can be electrically contacted via the connecting cable 13. This is possible in particular without interrupting the conductivity through the flat cable 7 and without previously stripping the flat cable.

FIGS. 1 and 2 further show that the flat cable 7 extends through the housing 1 in a first direction. This first direction is a direction of extent of the wires of the flat cable 7. Perpendicular to the first direction, a width direction can be defined as the direction in which the "width" of the flat cable 7 would be measured. The individual wires are arranged next to one another in the width direction. Perpendicular to the first direction and perpendicular to the width direction, the thickness direction can be defined as the direction in which the "thickness" of the flat cable 7 would be measured.

In addition to the elements outlined above of a connection system, the connection system of the present disclosure can have at least one spacer. Corresponding fastening means for fastening the spacer to the housing 1 of the connection system can further be provided on the connection system and/or on the spacer.

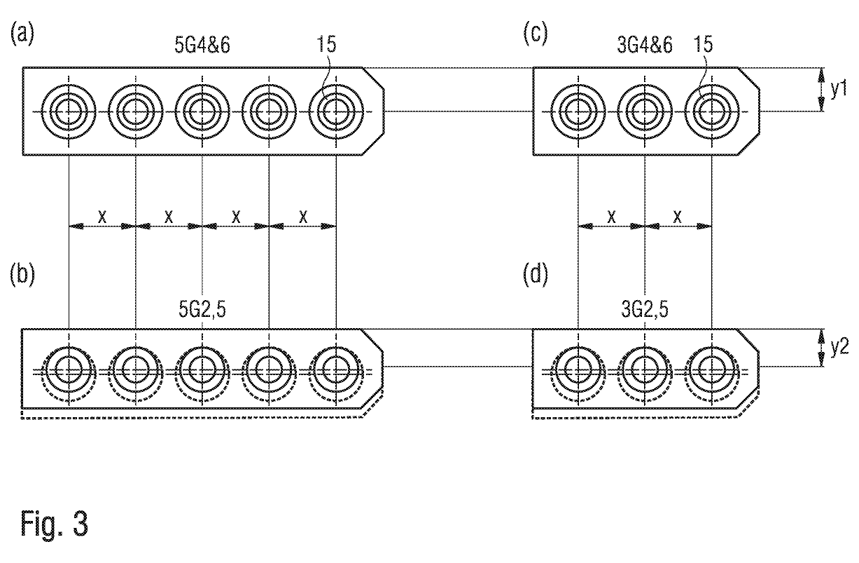

FIG. 3 shows cross sections through different types of ribbon cable 7 according to the present disclosure. The types of ribbon cable 7 are labelled in accordance with a harmonised labelling, wherein the first number represents the number of wires, the letter G represents the presence of a green-yellow protective earthing conductor, and the second number represents the conductor cross section in mm².

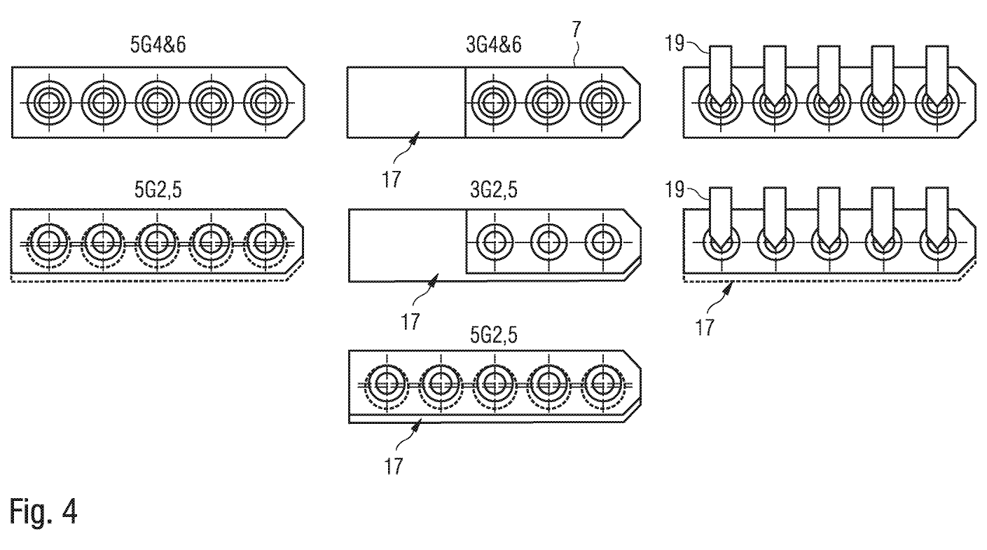

In the representation of FIG. 3 (and also of FIG. 4), the horizontal direction corresponds to the width direction, the vertical direction corresponds to the thickness direction, and the direction into the plane of the drawing corresponds to the first direction.

In section (a) of FIG. 3, a flat cable of type 5 G 4 and 5 G 6 is shown. In the following and in the figures, the spaces in the label are in some cases omitted. As outlined above, type 5G4 has five wires, the conductor cross section of which is in each case 4 mm².

In section (b) there is shown a cable of type 5G2.5, in section (c) a cable of type 3G4 and 3G6, and in section (d) a cable of type 3G2.5.

Where the types of flat cable are mentioned herein, this means the flat cables as shown in FIG. 3 and described in the following. In particular, this means flat cables that have a constant distance x between adjacent wires and in which this distance x between the wires is maintained in the case of flat cables having a different number of wires and is maintained in the case of flat cables having a different conductor cross section. The distance x between adjacent wires is – more precisely – a distance between the centre axes of the respective wires, that is to say in the sectional representation of FIG. 3 a distance between the centre points of the wires.

The cables of types 5G4/5G6 and 3G4/3G6 are shown together in a section because the respective ribbon cables do not have different external dimensions. Instead, the different conductor cross section in the case of the cables having a smaller conductor diameter (that is to say the cable of conductor cross section 4 mm²) is compensated for by thicker insulation of the respective wires. This is shown in sections (a) and (c) of FIG. 3 by the ring 15. In the case of the cables 5G6 and 3G6, this ring 15 is part of the conductor, while in the case of the cables 5G4 and 3G4 it is part of the insulation.

The cables 5G4 and 5G6 thus do not differ in terms of their external dimensions. The cables 3G4 and 3G6 also do not differ in terms of their external dimensions. Where mention is made in the following of the cable 5G4/5G6, this is one of the cables 5Gb or 5G6, the external dimensions of which are identical. Where mention is made in the following of the cable 3G4/3G6, this is one of the cables 3G4 or 3G6, the external dimensions of which are identical.

The individual wires (more precisely: the centre axes of the respective conductors) are in each case arranged at a distance x from one another. This distance x between the adjacent wires is identical within the particular type of flat cable.

Furthermore, this distance x is identical in the case of the cables of conductor cross section 2.5 mm², 4 mm² and 6 mm², as is shown by a comparison of sections (a) to (d) of FIG. 3. Thus, a width of the cables 5G2.5, 5G4 and 5G6 having an identical number of wires is also identical, see sections (a) and (b) of FIG. 3. The same is true for the width of the cables 3G2.5, 3G4 and 3G6 (see sections (c) and (d) of FIG. 3).

However, cables having different numbers of wires have different widths, as is shown by a comparison between the left-hand sections (a), (b) and the right-hand sections (c), (d) of FIG. 3. The more wires the flat cable has, the wider it is. The distance x between the adjacent wires is, however, identical in the types of flat cable having different numbers of wires.

The thickness of the cables of conductor cross section 2.5 mm² is different from the thickness of the cables of conductor cross section 4 mm² or 6 mm². This is indicated in sections (b) and (d) of FIG. 3 by the broken lines, which in each case represent the contours of the associated flat cable having a larger conductor cross section (that is to say 4 mm² and 6 mm²).

In particular, it is apparent from FIG. 3 that a distance from the midpoint of a conductor to the surface of the flat cable (in the thickness direction) varies between the cables of cross section 2.5 mm² and the cables of cross section 4 mm² and 6 mm². This distance y1 is larger in the case of the cables having a larger conductor cross section (4 mm² and 6 mm²) than a corresponding distance y2 in the case of the cables having a smaller conductor cross section (2.5 mm²).

In connection systems of the prior art, there had to be provided for each individual type of flat cable a separate connection system adapted for the respective type and having a suitable housing. This problem can be solved according to the present disclosure in particular by the provision of at least one suitable spacer, as will be explained in the following in particular with reference to FIG. 4.

In the left-hand column of FIG. 4, the two types of ribbon cable 5G4/5G6 and 5G2.5 are again shown one above the other. The middle column shows (from top to bottom) ribbon cables of type 3G4/3G6, 3G2.5 and 5G2.5. In the middle column, the ribbon cables have an associated spacer 17. The spacer 17 is so designed that, together with the respective flat cable 7, it has the external dimensions of the cable 5G4/5G6.

The cross section of the flat cable 5G4/5G6 thus represents a reference cross section for which the housing 1 is designed. Corresponding spacers 17 are provided for the other types of ribbon cable, in particular the types 3G4/3G6, 3G2.5 and 5G2.5 shown in the middle column of FIG. 4.

The flat cable 3G4/3G6 shown at the top of the middle column has the same thickness as the flat cable 5G4/5G6 but has a smaller width. This cable thus requires a spacer 17 of rectangular cross section, which is arranged in the housing 1 adjacent to the flat cable 7 in the width direction of the flat cable 7 (i.e. in the horizontal direction in FIG. 4). This spacer 17 is adapted, in an inserted state (i.e. in a state in which the spacer 17 has been inserted into the housing 1), to fill a space situated adjacent to the flat cable 7 in the width direction of the flat cable 7 (that is to say between the flat cable 7 and the housing 1).

The flat cable 3G2.5 shown in the middle of the middle column has a smaller thickness than the flat cable 5G4/5G6 and has a smaller width. This cable thus requires a spacer 17 of substantially L-shaped cross section, which is arranged in the housing 1 adjacent to the flat cable 7 in the width direction of the flat cable 7 (i.e. in the horizontal direction in FIG. 4) and adjacent to the flat cable 7 in the thickness direction of the flat cable 7 (i.e. in the vertical direction in FIG. 4). This spacer 17 is adapted, in an inserted state (i.e. in a state in which the spacer 17 has been inserted into the housing 1), to fill a space situated adjacent to the flat cable 7 in the width direction of the flat cable 7 (that is to say between the flat cable 7 and the housing 1) and to fill a space situated adjacent to the flat cable 7 in the thickness direction of the flat cable 7 (that is to say between the flat cable 7 and the housing 1).

The flat cable 5G2.5 shown at the bottom of the middle column has a smaller thickness than the flat cable 5G4/5G6 but has the same width. This cable thus requires a spacer 17 of substantially rectangular cross section (the bevelled portion shown in FIG. 4 is optional), which is arranged in the housing 1 adjacent to the flat cable 7 in the thickness direction of the flat cable 7 (i.e. in the vertical direction in FIG. 4). This spacer 17 is adapted, in an inserted state (i.e. in a state in which the spacer 17 has been inserted into the housing 1), to fill a space situated adjacent to the flat cable 7 in the thickness direction of the flat cable 7 (that is to say between the flat cable 7 and the housing 1).

At the top of the right-hand column of FIG. 4, the flat cable 5G4/5G6 is shown in a contacted state, and at the bottom of the right-hand column the flat cable 5G2.5 is shown in a contacted state. In the contacted state, needles 19 have pierced the respective conductors of the wires of the flat cable 7 (in the example shown: five needles 19 into five conductors) and thus establish electrical contact. As is shown in the right-hand column in FIG. 4, it is possible owing to the spacer 17 to use the same needles 19 with the same receivers 11 in order to establish reliable electrical contact between the respective needle 19 and the respective conductor.

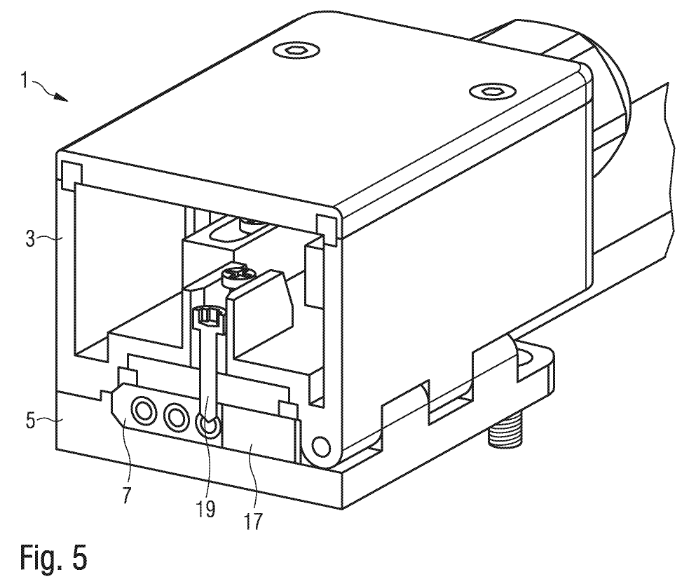

FIG. 5 shows a perspective sectional representation of a connection system according to the present disclosure. The connection system shown comprises a housing 1 having a main box 3 and a base plate 5, as shown in FIGS. 1 and 2 and described above. The connection system shown is in a connected state in which the housing 1 of the connection system is connected with a flat cable 7. The connection system is further in a contacted state in which the needles 19 of the connection system have pierced the respective conductors of the flat cable 7.

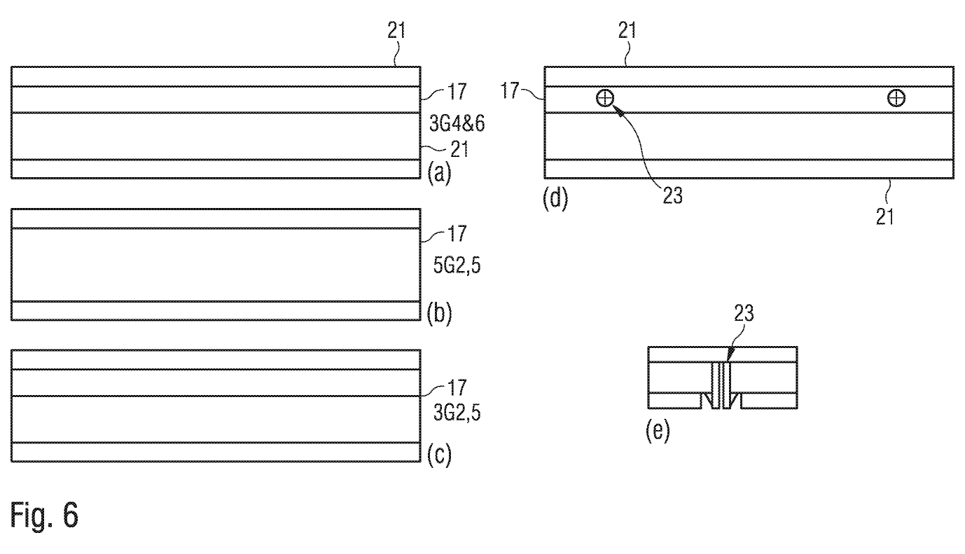

The flat cable 7 shown by way of example in FIG. 5 is of the 3G4 or 3G6 type, so that a lateral spacer 17 is provided, as shown at the top of the middle column in FIG. 4. The spacer 17 is in an inserted state in which it has been inserted into the housing 1. Corresponding fastening means can optionally be provided therefor, as is described in connection with FIG. 6. It should further be noted that in some exemplary embodiments the spacer 17 is not required for contacting a flat cable 7 that has a smaller number of wires than a flat cable having a maximum number of wires for which the particular connection system is designed. In this case, the flat cable of smaller width can, for example, be brought into contact with the housing 1 on one side of the cable and held there while the respective needles are inserted into the wires of the flat cable 7.

FIG. 6 shows in the left-hand column top views of different spacers 17. The same spacers 17 as in the middle column of FIG. 4 are here shown in a top view (but in a different order).

FIG. 6 (a) shows a top view of the "lateral" spacer 17 of cable types 3G4 and 3G6, as shown in cross section at the top of the middle column in FIG. 4. FIG. 6 (b) shows a top view of the "bottom" spacer 17 of cable type 5G2.5, as shown in cross section at the bottom of the middle column in FIG. 4. FIG. 6 (c) shows a top view of the "lateral and bottom", or L-shaped, spacer 17 of cable type 3G2.5, as shown in cross section in the middle of the middle column in FIG. 4. The regions 21 that are shown in FIG. 6 next to the respective spacer 17 (and that are provided with reference signs only in FIG. 6 (a) for reasons of clarity) are parts of an inner surface of the base plate 5 to which the respective spacer 17 is fastened. As shown in the left-hand column in FIG. 6, the spacers 17 can extend in the first direction over the entire length of the base plate 5.

The right-hand column of FIG. 6 shows, in sections (d) and (e), examples of different fastening means 23 for fastening the respective spacer 17 to the housing 1. In section (d) it is shown that screws can be provided as the fastening means 23. In this case, the spacer 17 has, for example, suitable holes for the passage of the screws and the housing 1 has associated threaded holes in the base plate 5 for screwing in the screws. Alternatively, the screws can, however, also be screwed in from beneath, wherein a hole having a thread is provided in the spacer 17.

Section (e) of FIG. 6 shows that a fastening clip can be used as the fastening means 23. In the example shown, this fastening clip is connected integrally with the spacer 17 and is pressed through an associated hole in the base plate 5 of the housing 1, in which it latches.

In the manner shown in sections (d) and (e), the respective spacer 17 suitable for a specific cable type can easily and quickly be connected with or inserted into the housing 1 of the connection system. The connection system can then be connected with the respective flat cable, for example by means of screws or a snap closure.

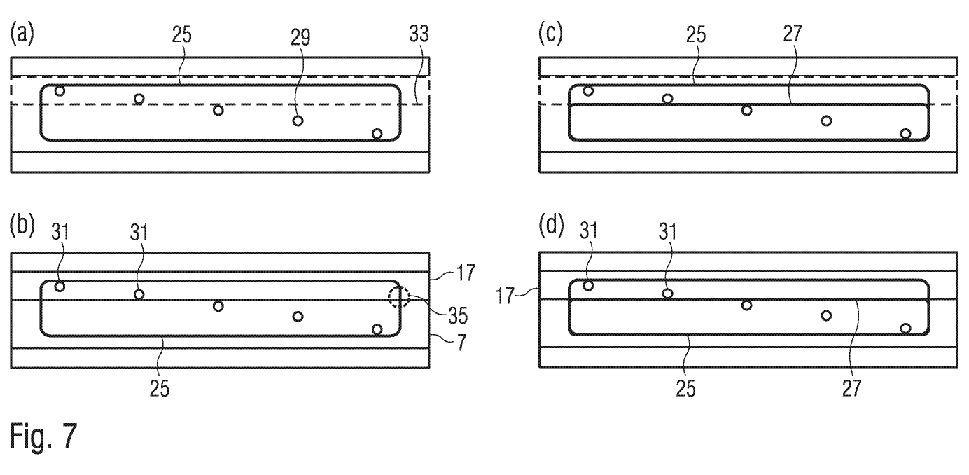

FIG. 7 shows top views of different flat cables 7 and of different spacers 17 and of different types of seal 25 for these elements. Sections (a) and (b) show a first example of a seal 25 having an annular sealing part, and sections (c) and (d) show a second example of a seal 25 having an annular sealing part and having an additional sealing part 27, which extends along a contact surface between the flat cable 7 and the spacer 17.

Sections (a) and (c) here show a situation in which a flat cable of type 5G4 or 5G6 is provided and thus no spacer is arranged in the housing 1. Sections (b) and (d) each show a situation in which a flat cable of type 3G4 or 3G6 is provided and a lateral spacer 17 has thus been inserted, as is shown at the top of the middle column in FIG. 6 (a) and FIG. 4. In sections (a) and (c), the position of the lateral spacer 17 is marked by a broken line 33.

The circles 29 mark the positions of the needles. As is apparent from FIG. 7, these positions of the needles are offset with respect to one another both in the first direction (the direction of extent of the flat cable 7) and in the width direction of the flat cable 7. A needle 19, or at least a receiver 11 for a needle 19, is provided for each wire of the flat cable 7 that is possibly present. In the case of a lateral spacer 17 (see sections (b) and (c)), recesses 31 (e.g. in the form of holes or blind holes) can be provided in this spacer 17 at the positions of the needles, said recesses allowing the respective needle 19 to be received and thus preventing the respective needle 19 from piercing the spacer 17.

The seal 25 shown in sections (a) and (b) is annular and thus consists of an annular sealing part. The seal 25 is arranged above the flat cable 7, or above the flat cable 7 and the spacer 17, and serves, for example, to avoid the ingress of moisture into an inner region of the annular sealing part and thus into a region in which the needles 19 have pierced the conductors of the flat cable 7. The seal 25 can thus be fixedly connected with the housing 1 and in particular with an outer lower side of the main box 3 of the housing 1. On connection of the housing 1 with the flat cable 7, the seal 25 can thus press on the flat cable 7 and optionally on the spacer 17 and provide corresponding sealing.

In some applications, the seal 25 of sections (a) and (b) may not be sufficient, since liquid can in some situations continue to enter in particular via a region 35 between the flat cable 7 and the spacer 17 through the gap that is present there.

It can thus be advantageous to provide an additional sealing part 27, as shown in FIG. 7 (c) and (d), which runs along an interface between the flat cable 7 and the spacer 17. The additional sealing part 27 runs from a point of the annular sealing part in the first direction to an opposite point of the annular sealing part. The additional sealing part 17 thus provides for sealing of a gap between the flat cable 7, the spacer 17 and the housing 1.

The seals 25 shown in FIG. 7 are optional and, for example, required only for a specific class of protection.

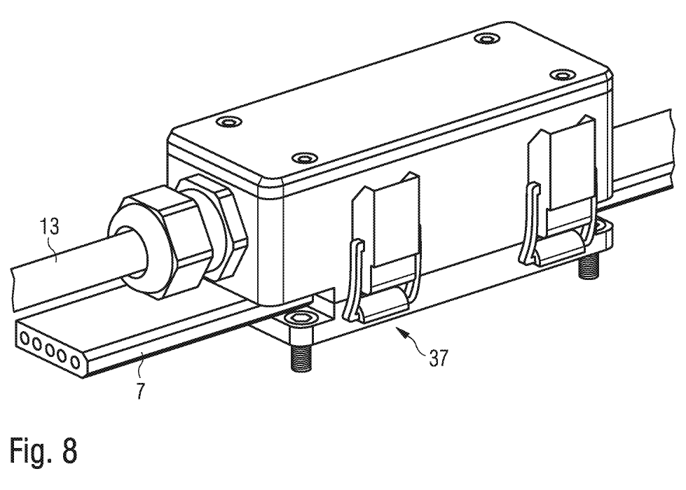

FIG. 8 shows a perspective outside view of a connection system according to the present disclosure having a snap closure 37 (also: quick-acting closure). The snap closure 37 represents one possibility for connecting the main box 3 with the base plate 5 of the housing 1. The flat cable 7 is here clamped between the main box 3 and the base plate 5 and thus connected with the housing 1. For example, snap closures 37 (e.g. two snap closures) can be arranged on one side of the housing 1, and hinges for pivotably fastening the base plate 5 to the main box 3 are provided on another, opposite side of the housing 1.

As an alternative to the snap closure 37 shown in FIG. 8, the side of the housing 1 on which the snap closure 37 is provided can be closed by means of screws, wherein, for example, the base plate 5 is screwed to the main box 3 or vice versa. Alternatively, the hinges can also be omitted and screws for screwing the main box 3 to the base plate 5 can be provided on both sides of the housing 1 (that is to say on both sides of the flat cable 7).

1. System for connection of a connection system with a first flat cable having a plurality of wires and/or with a second flat cable having a plurality of wires, wherein the system comprises:
(a) the first flat cable comprising a first number of wires arranged in a width direction of the first flat cable and each having a first conductor cross section, wherein all the distances between centre axes of adjacent wires are identical;
(b) the second flat cable comprising a second number of wires arranged in a width direction of the second flat cable and each having a second conductor cross section, wherein all the distances between centre axes of adjacent wires are identical and correspond to the distances of the first flat cable, and
wherein the first conductor cross section and the second conductor cross section differ from one another and/or wherein the first number of wires and the second number of wires differ from one another; and
(c) the connection system, comprising:
a housing for receiving the flat cable to be connected such that the flat cable to be connected runs through the housing in a first direction;
at least three receivers for in each case one needle for piercing in each case one of the wires of the flat cable to be connected,
wherein the at least three receivers are so arranged that, in a received state of the needles, the needles of the at least three receivers are arranged at the same distance from one another with respect to the width direction, perpendicular to the first direction, of the flat cable to be connected, said distance corresponding to the distance between the centre axes of the wires of the first flat cable and of the second flat cable.

2. System according to claim 1, wherein the connection system has at least five and in particular exactly five receivers, which are so arranged that, in the received state of the needles, the needles of the at least five receivers are arranged at the same distance from one another with respect to the width direction of the flat cable to be connected.

3. System according to claim 1, wherein the connection system further comprises at least one spacer for filling a space between the flat cable to be connected and the housing.

4. System according to claim 3, wherein the connection system further comprises at least one fastening means for fastening the spacer to the housing.

5. System according to claim 4, wherein the at least one fastening means comprises a screw, and wherein at least one hole for screwing in the screw is provided in each of the spacer and the housing.

6. System according to claim 4, wherein the at least one fastening means comprises a fastening clip,
wherein the fastening clip is provided on the spacer and is adapted to be inserted into and to latch in an opening provided therefor in the housing, or
wherein the fastening clip is provided on the housing and is adapted to be inserted into and to latch in an opening provided therefor in the spacer.

7. System according to claim 3, wherein the spacer is adapted to fill, in an inserted state, a space situated adjacent to the flat cable in the width direction of the flat cable to be connected, and/or
wherein the spacer is adapted to fill, in an inserted state, a space situated adjacent to the flat cable in a thickness direction of the flat cable to be connected.

8. System according to claim 3, wherein the spacer is adapted to extend, in an inserted state, at least over the entire flat cable in the width direction of the flat cable to be connected, and/or
wherein the spacer is adapted to extend, in an inserted state, at least over the entire flat cable in the thickness direction of the flat cable to be connected.

9. System according to claim 3, comprising a plurality of spacers for flat cables of different widths and/or of different thicknesses.

10. System according to claim 3, wherein the spacer, in an inserted state, comprises a recess at a position of at least one of the receivers.

11. System according to claim 1, wherein the connection system further comprises a seal arranged between the housing and the flat cable and having an annular sealing part.

12. System according to claim 11, wherein the seal comprises, in addition to the annular sealing part, a sealing part that runs along a contact surface between the flat cable and the spacer.

13. System according to claim 1, wherein the connection system comprises the needle.

14. Connection system for connection with a first flat cable having a plurality of wires and/or with a second flat cable having a plurality of wires, wherein the connection system comprises:
a housing for receiving the flat cable to be connected such that the flat cable to be connected runs through the housing in a first direction;
at least three receivers for in each case one needle for piercing in each case one of the wires of the flat cable to be connected;
wherein the at least three receivers are so arranged that, in a received state of the needles, the needles of the at least three receivers are arranged at the same distance from one another with respect to the width direction, perpendicular to the first direction, of the flat cable to be connected; and
at least one spacer for filling a space between the flat cable to be connected and the housing.

15. Connection system according to claim 14, wherein the connection system has at least five and in particular exactly five receivers, which are so arranged that, in the received state of the needles, the needles of the at least five receivers are arranged at the same distance from one another with respect to the width direction of the flat cable to be connected.
